(19) United States
(12) Patent Application Publication
(10) Pub. No.: US 2009/0141486 A1
(43) Pub. Date: Jun. 4, 2009

(54) Internal lighting device for furniture

(76) Inventor: Carlo Migli, Lecco LC (IT)

Correspondence Address: JACOBSON HOLMAN PLLC, 400 SEVENTH STREET N.W., SUITE 600, WASHINGTON, DC, 20004, US

(21) Appl. No.: 12/292,834

(22) Filed: Nov. 26, 2008

(30) Foreign Application Priority Data
Dec. 3, 2007 (IT) MI2007A 002264

(51) Int. Cl. F21L 4/00

(52) U.S. Cl. 362/191

(57) ABSTRACT

A device for the automatic battery-powered internal lighting of the interior of a piece of furniture, comprises a body provided with fixing means for fixing to the piece of furniture and a chamber containing an electric battery and a lighting source and from which there protrudes frontally the control end of a pushbutton contact that also constitutes the cover of the battery chamber at a pole of the battery.

### BACKGROUND OF THE INVENTION

1. Field of the Invention

The present invention relates to an internal lighting device for furniture.

2. State of the Prior Art

In the prior art small battery devices are known that can be arranged inside a piece of furniture, generally a cupboard, to illuminate the interior thereof. Some of these devices have a switch-on pushbutton that is arranged so as to automatically switch off the device when the piece of furniture is closed.

The general object of the present invention is to provide lighting devices for furniture that have a simple, tough and cheap structure and enable the battery to be changed easily.

### SUMMARY OF THE INVENTION

In view of this object it was decided to devise, according to the invention, a device for an automatic battery-powered lighting device for lighting the interior of a piece of furniture, comprising a body provided with fixing means for fixing to the piece of furniture and a chamber containing an electric battery and a lighting source and from the front of which there protrudes the control end of a normally closed pushbutton contact for connecting the battery to the lighting source when the piece of furniture is opened, characterized in that the control end also constitutes the cover of the battery chamber at a battery pole.

### BRIEF DESCRIPTION OF THE DRAWINGS

In order to make clearer the explanation of the innovative principles of the present invention and the advantages thereof with respect to the prior art, with the help of the enclosed drawings possible embodiments thereof will be disclosed below by way of non-limiting example. In the drawings:

FIG. 1 is an exploded perspective view of a first lighting device made according to the principles of the invention;

FIG. 2 is a lateral section view of the device in FIG. 1 mounted in a piece of furniture;

FIG. 3 is a perspective view of the device in FIG. 1 assembled;

FIG. 4 is an exploded perspective view of a second lighting device made according to the principles of the invention;

FIG. 5 is a lateral section view of the device in FIG. 4 mounted in a piece of furniture;

FIG. 6 is a perspective view of the assembled device in FIG. 4;

FIG. 7 is a top plan view of the device in FIG. 6. With reference to the figures, in FIG. 1 there is shown the exploded view of a first device according to the invention, indicated generally by 10.

### DETAILED DESCRIPTION OF THE INVENTION

The device 10 comprises a body 11 (advantageously molded from plastics) provided with fixing means 12 for fixing to the piece of furniture and with a chamber 13 containing an electric battery 14. In the body there is also a lighting source 15 (advantageously a high-luminosity white LED) that protrudes outside to project a beam of light. From a front end of the body there protrudes the control end or pushbutton 16 of a normally closed pushbutton contact to connect the battery to the lighting source when the piece of furniture is opened.

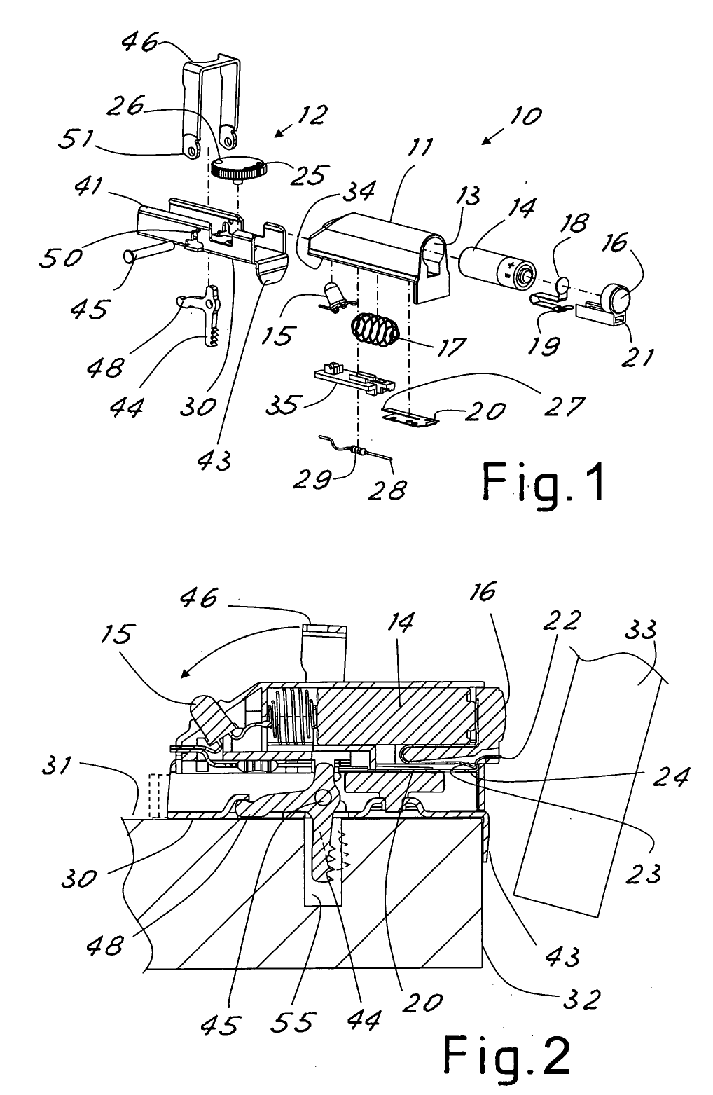

As can be seen clearly in FIGS. 1 and 2, the chamber for receiving the battery (of pen type) extends according to the main axis of the device, i.e. the axis coinciding with the thrust direction on the on/off control end 16. At the bottom of the chamber 13 there is a contact spring with a battery pole whilst the opposite end of the chamber, which is the axial insertion end of the battery, is closed by the control end 16, which is slidable mounted on the open end of the chamber and which also constitutes the cover or cap of the battery chamber at the other battery pole. The chamber is generally cylindrical, to accommodate the pen battery with minimum clearance, like the pushbutton 16.

The control end 16 supports a contact blade 18 inside the chamber intended for resting on the facing battery pole. The blade extends to form a contact tongue 19 that normally rests on a second contact blade 20 supported in the body 11 and which constitutes the fixed contact of the pushbutton switch. The rest between the tongue 19 and the blade 20 is such that the electric contact between the tongue 19 and the blade 20 is interrupted when the pushbutton 16 is pushed inside the chamber 13 against the action of the spring 17. The tongue 19 is advantageously received in a box-shaped protrusion on a side of the pushbutton 16.

Also advantageously, the tongue 19 also constitutes a removable fixing means for maintaining the pushbutton 16 fixed in the seat 13 during normal operation of the device. For this purpose, the tongue 19 has a bent end that protrudes frontally on the pushbutton 16 in a suitable seat 21 to constitute an end 22 for the manual control for unhooking a tooth 23 of the tongue from an abutment 24. The abutment 24 can advantageously coincide with an end of the fixed contact 20. The tooth 23 advantageously has a tilted surface for elastically flexing the tongue 19 when the pushbutton 16 is inserted into the seat and for then snapping into the lock position against the abutment 24.

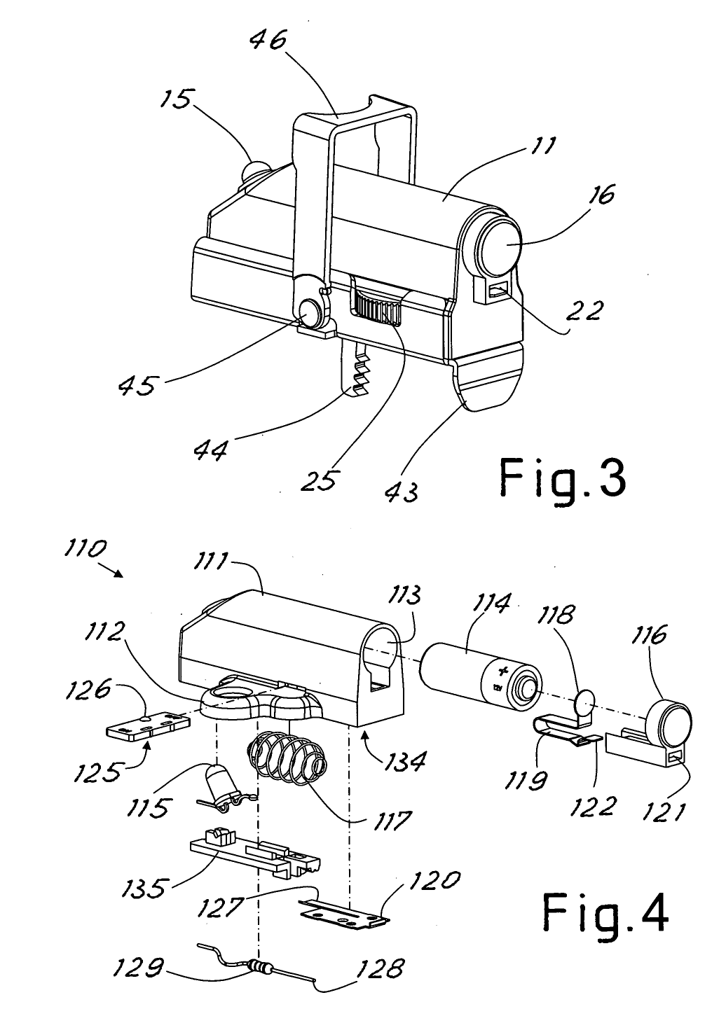

Advantageously, the fixed contact 20 is connected to the lighting source by interposing an overriding switch arranged serially on the circuit to enable the lighting to be switched off even when the pushbutton 16 is not pressed. In the shown embodiment, the overriding switch comprises a control wheel 25, pivoted in the device and protruding laterally therefrom (as can be seen clearly in FIG. 3) to be manually rotatable. The control wheel has a protrusion 26 (FIG. 1) that, depending on the angular position of the wheel, pushes or does not push an end 27 of the contact blade 20 to move the contact blade 20 and open the circuit that it forms to the lighting source or to close the circuit. Advantageously, the end 27 normally rests on a conductor 28 of a resistor 29 limiting the supply current of the LED, sparing the use of a further contact blade.

As can be seen clearly in FIGS. 2 and 3, the fixing means 12 defines a mounting surface 30 intended to rest on the internal surface 31 of the piece of furniture. The lighting source is advantageously at the end of the body 11 opposite the pushbutton 16 and is tilted with respect to the axis movement of the pushbutton and directed away from the fixing surface. In this manner it appropriately illuminates the interior of the piece of furniture.

As can be seen clearly in FIG. 2, the device 10 is intended to be positioned near an edge 32 of the surface 31 of the piece of furniture that is an abutment for the element 33 of the piece of furniture (e.g. a slidable front or a hinged door, generally shown semi-open in FIG. 2) that closes the space of the piece of furniture that it is desired to light so that the pushbutton 16 is pressed by the element 33 in a closed position and is released when the element 33 is opened.

In the first disclosed embodiment, the fixing means advantageously comprises an abutting tongue 43 and an engaging tooth 44, that face one another and are generally parallel. The tooth 44 is supported on the body by a pivot 45 and is movable between a rest position (solid line in FIG. 2) and an engaging position (dashed line in FIG. 2) by activating an operating lever 46 that moves from a vertical position to a rear lowered position. Advantageously, the tooth 44 has an edge facing the tongue 43, which is deeply serrated. The fixing means can be fixed to a base 41 in which the body 11 is inserted as a drawer.

In order to produce movement of the tooth, the lever is provided with cam surfaces 51 that produce the transverse sliding of the pivot along guide grooves 50, moving the pivot away from the surface 30 when the lever 46 moves to the hooking position. The tooth 44 has a square arm 48 fixed to an end to cause the tooth to rotate when the pivot 45 slides in the grooves 50.

The abutting tongue 43 is intended to rest on the edge 32 of the piece of furniture, ensuring precise positioning of the pushbutton 16 and resistance to shocks due to the closing of the piece of furniture, whilst the tooth 44 is intended to be inserted into a hole 55 in the surface of the piece of furniture to obtain a removable fixture. This hole can be part of a series of standard holes along the back of the piece of furniture for fixing other accessories (for example the hinges of the door).

Advantageously, assembling the various parts of the device inside the body 11 occurs through a lower opening 34 of this body that is closed by a plate 35 made of plastics that is snap-inserted.

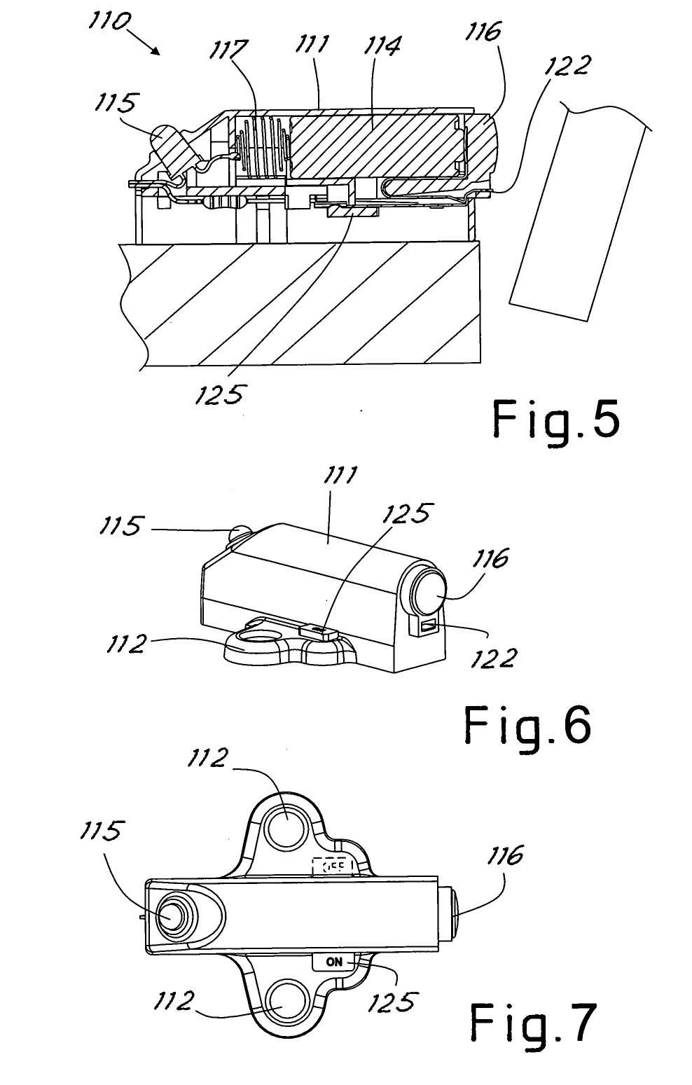

In FIGS. 4 to 7 there is shown a version of the disclosed device. For the sake of simplicity, elements corresponding to those of the embodiment in FIG. 1 are shown by the same numbering increased by 100.

There is thus a device 110 that comprises a body 111 (advantageously molded from plastics) provided with fixing means 112 for fixing to the piece of furniture and with a chamber 113 containing an electric battery 114. To the rear and in a tilted position there protrudes a lighting source 115 (advantageously a high-luminosity white LED).

The battery chamber is closed by the slidable control end or pushbutton 116 and supports the contact 118 for a battery pole. The opposite pole of the battery rests on a contact spring 117. A plate 135 snaps shut a lower opening 134 of the body 111 through which the various internal parts of the device are introduced.

The contact blade 118 extends to form a contact tongue 119 that normally rests on a second contact blade 120 supported in the body 111 and which makes the fixed contact of the pushbutton switch.

In a manner that is completely similar to that of the tongue 19 of the preceding embodiment, the tongue 119 ends with an end 122 that protrudes from a seat 121 facing the pushbutton 116 to enable the pushbutton to be unhooked by as much as desired to open the chamber 113 to change the battery.

Also in this embodiment the fixed contact 120 is connected to the lighting source by interposing an overriding switch that enables the light to be switched off even when the pushbutton 16 is not pressed. In this second embodiment, the overriding switch comprises a cursor 125 that slides transversely to the main axis of the device to have ends that protrude alternatively to the right or left of the body ill, as shown schematically in FIG. 7.

On the cursor there is a protrusion 126 which, depending on the position of the cursor, does or does not deviate an end 127 of the contact blade 120 to move the contact blade 120 and open the circuit that it forms towards the lighting source or to close the circuit. The end 127 can close the circuit, resting directly on a conductor 128 of a resistor 129 limiting the supply current of the LED.

The positioning of the device 110 in the piece of furniture is similar to that of the device 10. The fixing means 112 is, however, formed of single flaps that protrude on both sides of the device through traditional screw fixing and/or with suitable known plugs.

At this point it is clear how the preset objects have been reached.

Naturally the above description of an embodiment applying the innovative principles of the present invention is given by way of non-limiting example of what is claimed herein. For example, other fixing means may be imagined by those skilled in the art.

What is claimed is:

1. Device for battery-operated automatic lighting of the interior of a piece of furniture, comprising a body provided with fixing means for fixing to the piece of furniture and a chamber containing an electric battery and a lighting source and from which there protrudes frontally the control end of a normally closed pushbutton contact for connecting the battery to the lighting source when the piece of furniture is opened, characterized in that the control end also constitutes the cover of the battery chamber at a battery pole.

2. Device according to claim 1, characterized in that the control end supports a contact blade for the battery pole, the blade extending in a tongue that constitutes the pushbutton electric contact that disconnects the electric circuit between the battery and lighting source when the control end is pushed inside the battery chamber.

3. Device according to claim 1, characterized in that the chamber contains a spring on the bottom at the other pole of the battery to constitute an electric contact with the other pole and enable slidable movement towards the inside of the pushbutton together with the battery against the action of the spring.

4. Device according to claim 2, characterized in that the tongue that extends from the contact blade with the battery also constitutes an engaging means that is releasable from outside to remove the cover in the form of said control end, closing the battery chamber.

5. Device according to claim 1, characterized in that it comprises un overriding serial manual switch on the supply circuit between the battery and the lighting source.

6. Device according to claim 5, characterized in that the overriding switch is constituted by a wheel the rotation of which controls a respective connecting or disconnecting movement of a part of a serial electric contact on the circuit.

7. Device according to claim 5, characterized in that the overriding switch is constituted by a slide cursor arranged transversely to the main axis of the device to be manually moved to protrude from one or another side of the body and to control respective movement of a serial electric contact on the circuit.

8. Device according to claim 1, characterized in that the lighting source is a LED.

9. Device according to claim 1, characterized in that the lighting source is directed to the rear of the device and is tilted in relation to the main axis of the device in a direction opposite a mounting surface of the device on the piece of furniture.

10. Device according to claim 1, characterized in that the fixing means for fixing to the piece of furniture comprises flaps protruding laterally from the body and with seats for fixing screws.

11. Device according to claim 1, characterized in that the fixing means for fixing to the piece of furniture comprises an engaging system engaging with the piece of furniture with an abutting tongue, intended to rest at a corner of the surface of the piece of furniture, and a tooth that faces the abutting tongue and is intended to be inserted into a hole on said surface of the piece of furniture, a hooking lever being rotatable from a hooking position to an unhooking position, controlling the movement of means for moving the tooth to the tongue to cause the tooth to engage in the wall of the hole with a reaction on the tongue resting on the corner of the piece of furniture.

12. Device according to claim 11, characterized in that the movement-towards means comprises cam surfaces on the end of the lever hinged on the body and commands a transverse movement of the pivot on which the tooth is also fixed, the tooth having a square arm with an end fixed to produce a tilt of the tooth towards the abutting tongue when the pivot is moved by the lever that moves to the hooking position.
